(19) United States
(12) Patent Application Publication
(10) Pub. No.: US 2005/0106378 A1
(43) Pub. Date: May 19, 2005

(54) Corrugated foam/film laminates

(75) Inventors: David Rives, Sparta, NJ (US); Natarajan S. Ramesh, Grapevine, TX (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sealed Air Corporation (US), Saddle Brook, NJ (US)

(21) Appl. No.: 10/716,922

(22) Filed: Nov. 19, 2003

(51) Int. Cl. C08J 9/00; B32B 3/26; B32B 3/00; B32B 9/00

(52) U.S. Cl. 428/304.4; 428/314.4; 428/312.8; 428/318.4; 428/319.1

(57) ABSTRACT

A laminate for use as a thermal insulating material includes a layer of a metal laminated to an expanded foam web. The foam web is formed with a plurality of ribs projecting from one surface of the web in the length direction thereof. The metal layer is laminated to the free edges of the ribs so as to define a plurality of closed channels extending in the length direction of the laminate. The metal layer may include a layer of a polymer to facilitate adherence of the metal layer to the foam web.

### BACKGROUND OF THE INVENTION

The present invention relates to expandable foams, and more particularly to expandable foams for use in building insulation. Still more particularly, the present invention is directed to laminates of a film and an expandable foam useful as an insulating material and moisture barrier in the construction of buildings, the manufacture of appliances, and other applications.

Films and laminates of various types have been used as protective layers during the construction of buildings. These layers are often used to prevent water infiltration into a building while allowing air and vapors to escape. Among the currently most popular of these films are non-woven fabrics of polymer fibers, particularly polyethylene fibers. These materials are typically expensive to manufacture, difficult to install and require a balance of properties between resistance to moisture penetration and high vapor transmission without allowing direct admission of air. Moreover, complex manufacturing processes are often required in order to tailor the attributes of these materials so as to obtain the properties desired.

There therefore exists a need for a material which is easy and cost-effective to manufacture and easy to install during the construction of buildings, and which provides thermal insulating properties as well as an effective barrier to moisture. Preferably, such material also will be useful in other insulating applications, such as to insulate appliances, as a floor underlayment and the like.

### SUMMARY OF THE INVENTION

The present invention addresses these needs.

According to the present invention, an insulating material includes a foam web including a polymer matrix and a multiplicity of voids dispersed throughout the polymer matrix. The foam web extends in a length direction and has first and second surfaces, with a plurality of spaced ribs projecting from the first surface and oriented in the length direction. A film including a metal layer is adhered to free edges of the spaced ribs so as to define a plurality of enclosed channels extending in the length direction, each of the enclosed channels being delimited by the foam web, the film and an adjacent pair of the ribs. The metal layer desirably includes a continuous layer of metal. Preferably, the metal layer is formed from aluminum, and in particular, an aluminum foil.

In preferred embodiments, the film includes a polymer layer disposed between the metal layer and the foam web. The polymer layer preferably is formed from a polyolefin. More preferably, the polymer layer in the film is formed from substantially the same polymer as the polymer matrix in the foam web. Still more preferably, both the foam web and the polymer layer in the film are formed from polyethylene. Films for use in the present invention desirably have a thickness between about 0.5 mil and about 20 mils. The metal layer may include at least one additive selected from the group consisting of antioxidants, anti-corrosion agents, anti-bacterial agents, anti-microbial agents, anti-fungal agents, anti-static agents, UV stabilizers and biostabilizers.

The foam web has a predetermined thickness between the first and second surfaces, and the ribs project from the first surface by a height dimension. Preferably, the height dimension is greater than the predetermined thickness of the web. More preferably, the height dimension is at least about twice the predetermined thickness. The overall thickness of the foam web, including the predetermined thickness and the height dimension, may be between about 0.02 inches and about 4 inches. Each of the ribs may be separated from an adjacent rib by any amount, but preferably by at least the width of the ribs at their junction with the first surface.

Desirably, the foam web has a density between about 0.5 lb/ft³ and about 15 lb/ft³. The foam web may include at least one additive selected from the group consisting of antioxidants, colorants, anti-corrosion agents, anti-bacterial agents, anti-microbial agents, anti-fungal agents, anti-static agents, UV stabilizers, fillers, reinforcements, biostabilizers and pigments.

In embodiments of the invention, the laminate may include another film adhered to the second surface of the foam web. The another film may be formed from high density polyethylene. The another film may also include a metal layer. In certain embodiments hereof, the another film may be formed from the same material as the film.

### BRIEF DESCRIPTION OF THE DRAWINGS

A more complete appreciation of the subject matter of the present invention and the various advantages thereof can be realized by reference of the following detailed description in which reference is made to the accompanying drawings, in which:

FIG. 1 is a highly schematic view showing a process for forming an expanded foam web in accordance with the present invention;

FIG. 2 is a highly schematic view showing a process for laminating a film to the expanded foam web;

FIG. 3 is a highly schematic cross-sectional view of a film/foam laminate according to the present invention;

FIG. 4 is a highly schematic plan view of the film/foam laminate of FIG. 3 with the film layer partially broken away to show the underlying foam layer; and

FIG. 5 is a highly schematic cross-sectional view of a film/foam laminate according to an alternate embodiment of the present invention.

### DETAILED DESCRIPTION

Preferred processes for forming film/expanded foam laminates according to the present invention generally include the steps of (1) providing a mass of a polymer in a flowable state; (2) incorporating a blowing agent in the polymer mass; (3) forming the polymer/blowing agent mixture to a desired corrugated shape; (4) expanding the blowing agent to form a corrugated foam structure consisting of a phase of pores or cells dispersed throughout a polymer matrix; (5) solidifying the foam structure; and (6) adhering a layer of metal to the corrugated side of the foam structure. Polymers, additives and blowing agents useful in the present invention, as well as methods for combining these materials and forming same into expanded foam structures, are well known in the art and include those disclosed in commonly assigned U.S. Pat. Nos. 5,667,728 and 6,030,696, the disclosures of which are hereby incorporated by reference herein. In the expanded foam structures for use in the present invention, greater than about 60 percent of the cells preferably are closed. In use, such closed cell foam structures will not collapse or lose substantial thickness if a normal load is applied to the structure, and therefore such structures will better maintain their insulation value. It will be appreciated, however, that the present invention also contemplates use of open cell expanded foam structures which are often used to attenuate sound.

The polymers which may be used to form the expanded foam portion of the present invention include any foamable thermoplastic or thermosetting materials, including blends of two or more thermoplastic materials, blends of two or more thermosetting materials, or blends of thermoplastic materials with thermosetting materials. Suitable polymers include polystyrene, polyolefins, polyurethanes, polyesters including polyethylene terephthalate, and polyisocyanurates, with polyolefins being particularly preferred. Polyolefins are thermoplastic polymers derived from unsaturated hydrocarbons containing the ethylene or diene functional groups. Although the polyolefins may include virtually all of the addition polymers, the term “polyolefin” ordinarily refers to polymers of ethylene, the alkyl derivatives of ethylene (the alphaolefins), and the dienes. Among the more commercially important polyolefins are polyethylene, polypropylene, polybutene, and their copolymers, including ethylene/alpha-olefin copolymers such as linear low density polyethylene, and blends of the foregoing materials. Polyethylene is particularly useful in the practice of the present invention.

Polyethylene is a whitish, translucent polymer of moderate strength and high toughness which is available in varieties ranging in crystallinity from 20 to 95 percent, and an ultra low, low, medium and high density polymer forms. The low density material has a softening temperature between about 95° C. and about 115° C., while the high density material has a softening temperature between about 130° C. and about 140° C. Low, medium and high density polyethylenes and mixtures thereof are suitable for extrusion forming.

The present invention may utilize any of the known blowing agents, including fluorocarbons; hydrofluorocarbons; chlorofluorocarbons; hydrochlorofluorocarbons; alkylhalides, such as methyl chloride and ethyl chloride; and hydrocarbons. Other suitable blowing agents may include pristine blowing agents such as air, carbon dioxide, nitrogen, argon, water and the like. The blowing agent may consist of a mixture of two or more of any of the blowing agents set forth above. Other suitable blowing agents may also include chemical blowing agents such as ammonium and azotype compounds, including ammonium carbonate, ammonium bicarbonate, potassium bicarbonate, diazoaminobenzene, diazoaminotolulene, azodicarbonamide, diazoisobutyronitrile, and the like.

Preferred blowing agents in accordance with the present invention are hydrocarbons, including butane, isobutane, pentane, isopentane, hexane, isohexane, heptane, propane and the like, including combinations of two or more of these materials. A particularly preferred blowing agent for use with polyethylene is propane.

In addition to the polymer and the blowing agents, the mixtures for forming the foam structures of the present invention may include one or more additives for enhancing the properties of the foam and the forming process. For example, elastomeric components such as polyisobutylene, polybutadene, ethylene/propylene copolymers, and ethylene/propylene diene interpolymers may be incorporated in the mixture. Other potential additives include cross-linking agents, extrusion aides, antioxidants, colorants, UV stabilizers, anti-microbial agents, anti-fungal agents, anti-corrosion agents, anti-bacterial agents, anti-static agents, fillers, reinforcements, fiber reinforcements, biostabilizers, pigments, etc. as desired, all of which are conventional in the art.

The mixture may also include one or more permeability modifiers for controlling the replacement of the blowing agent in the cells of the foam with air while preventing substantial shrinkage of the foam structure from premature excessive loss of the blowing agent. Suitable permeability modifiers include fatty acid esters and amides such as glycerol monostearate and stearyl stearamide. The permeability modifier is used in an amount sufficient to produce a desirable rate of exchange of air with blowing agent in the cells of the foam. This amount is generally dictated by the polymer matrix material, the blowing agent composition and quantity, processing conditions, etc. For mixtures in which the polymer is polyethylene and the blowing agent is propane, a permeability modifier consisting of a 2:1 mixture of glycerol monostearate in monoethanolamide may be mixed with the polyethylene, preferably prior to melting, in an amount from about 0.3 to about 5 percent by weight of the polyethylene. Glycerol monostearate/monoethanolamide additions of about 0.3 to about 2.0 percent by weight of the polyethylene are preferred. On the other hand, where the polymer is polypropylene, permeability modifiers are not typically needed, but may be used in appropriate quantities to reduce friction-induced static in the polymer and foams.

A nucleation agent may also be added to the mixture to promote nucleation and to control cell development and size. Preferred nucleating agents include low activity metal oxides, such as zinc oxide, zirconium oxide and talc; sodium bicarbonate/citric acid blends, such as those available under the trademark Hydrocerol from Clariant Corporation of Winchester, Va.; and other materials known in the art. The amount of nucleating agent added to the mixture will depend upon the composition and activity of the nucleating agent, the composition of the polymer matrix material, the blowing agent composition and quantity, and processing conditions, as well as upon the pore size and pore density desired in the expanded foam. Sodium bicarbonate/citric acid nucleating agents preferably are added in an amount from about 0 to 1.5 percent by weight of the polymer. For polyethylene/propane mixtures, additions of such nucleating agents in amounts between about 0.05 and 0.50 percent by weight of polyethylene are preferred. Talc, which is less active, is preferably added as a nucleating agent in an amount of from about 0 to 2 percent by weight of the polymer, with additions of between about 0.2 and 1.0 percent by weight of polyethylene being preferred in polyethylene/propane mixtures.

Once the polymer and additives have been selected, these materials are mixed together to form a mixture. This may be accomplished in a conventional batch mixing step. Alternatively, where the foam structures are to be formed by extrusion, pellets of a thermoplastic polymer may be placed in the hopper of an extruder. Any nucleating agents, permeability modifiers and/or other additives may be added to the hopper and combined in a solid state with the polymer pellets to form a homogenous mixture. Intimate mixing of these components is important to assure uniform pore distribution throughout the extruded foam as well as uniform blowing agent dissipation from the expanded foam. The solid mixture may then be conveyed to the melt zone of the extruder in which the mixture is thoroughly melted. The mixture should be brought to a high enough temperature above its melting point to have sufficient fluidity for mixing with the blowing agent. Temperatures which are between about 20° C. and about 100° C. above the melting point of the polymer are preferred. The melt zone may be maintained at a somewhat lower temperature due to the heat that is generated by friction as the melted mixture flows through the extruder.

The melted mixture may then be metered to a mixing zone where it is mixed with the blowing agent under pressure. The blowing agent typically is injected between the metering and mixing zones, and through either a single port or multiple ports, using high pressure pumps. Where the blowing agent includes more than one component, the components may be injected separately through multiple ports or in combination through a single port. When injected, the blowing agent initially forms a dispersion of insoluble bubbles within the melted thermoplastic mass. These bubbles eventually dissolve in the thermoplastic mass as the mixing continues and the pressure increases down the length of the extruder. Desirably, the extruder has a length to diameter ratio of at least 30:1 and a mixing zone with a sufficient length to ensure that a homogenous mixture is formed. In this regard, single screw extruders may be used in processes according to the present invention, although double screw extruders may be used for greater mixing. Double screw extruders may be either twin screw, in which the mixture passes through two screws arranged parallel to one another, or tandem screw, in which the mixture passes through two screws arranged in series.

The blowing agent generally is added to the molten polymer in amounts of between about 3 and about 20 percent by weight of the polymer. For polyethylene/propane mixtures, the propane preferably is added in amounts of between about 5 and about 15 percent by weight of polyethylene, depending on the thickness of the foam. Where lower density foams are desired, greater amounts of blowing agent are typically added. Thus, the maximum useful proportion of blowing agent in the molten mass is density related. The quantity of blowing agent also is related to the pressure that is maintained on the molten polymer/blowing agent mixture in the extrusion die passage.

After mixing, the temperature of the polymer/blowing agent mixture should be lowered to a temperature which is closer to its melting point so that the blowing agent does not readily escape from the polymer upon expansion, thereby enabling the polymer to maintain its structure upon foaming. However, overcooling of the mixture may hinder complete expansion of the foam, and therefore should be avoided. The blowing agent has a plasticizing effect on the polymer mixture, reducing its viscosity or resistance to flow, and so the melting point of the polymer/blowing agent mixture ordinarily is below that of the polymer alone. The expansion temperature, which is above the melting point of the polymer/blowing agent mixture, may be empirically determined and depends upon the composition of the polymer, the length of the extruder screw, whether single or double screws are used, and on the composition and amount of the blowing agent. For a low density polyethylene, the expansion temperature generally will be in the range of between about 85° C. and about 120° C.

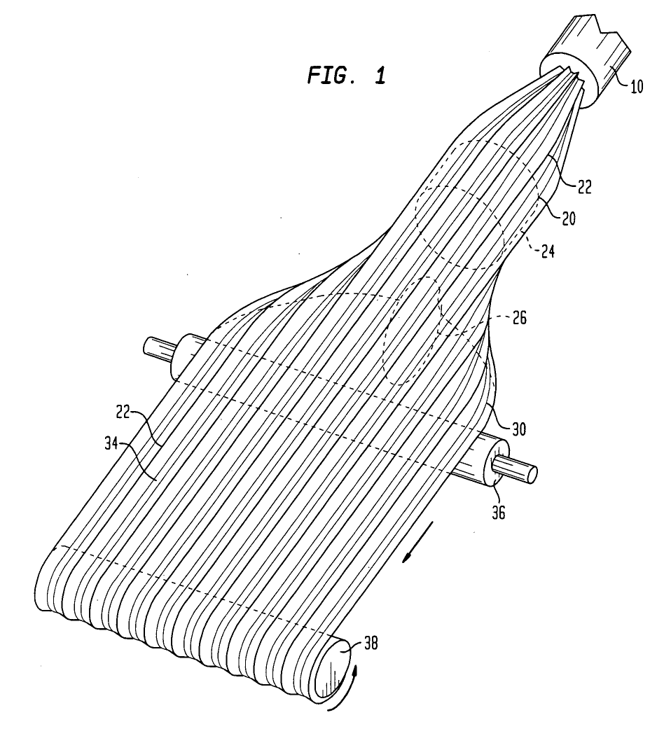

FIG. 1 is a highly schematic diagram illustrating the extrusion process and subsequent steps for forming an expanded foam web. When cooled to the appropriate temperature, the polymer/blowing agent mixture may be extruded through a die 10 having an appropriate shape. For making corrugated foam webs for use in the present invention, a die having an annular shape for extruding a foam tube is preferred. The annular die preferably has an inner fixture with a smooth circular surface, and an outer fixture formed with regularly spaced notches having dimensions suitable to form ribs of a desired width and depth projecting from the extruded foam structure. As used herein, foam webs that are “corrugated” are those in which at least one surface of the web has a series of alternating peaks and valleys which extend in the length direction of the web.

Within die 10, the polymer/blowing agent mixture is under high pressure which prevents the foam from expanding. As it exits the die, however, the mixture is exposed to a low pressure environment, such as atmospheric pressure. This sudden drop in pressure causes bubble nucleation and expansion or foaming of the structure. As it exits annular die 10, the mixture may be extruded into a tubular-shaped expanded foam structure 20 having a smooth circular inner circumference and an outer circumference formed with a series of spaced ribs 22. The tubular-shaped structure may then be passed over a water-cooled can 24 which cools and solidifies the expanded foam. As it leaves the cooling can 24, the tubular foam structure 20 is slit longitudinally by a rotary knife 26 and opened to form a web 30 having a substantially flat surface 32 on one side thereof and a surface 34 on the other side thereof with ribs 22 projecting therefrom to thereby define a corrugated surface. Web 30 may be cast over a water-cooled ring or roller 36 with surface 32 in contact with the ring so as to cool the structure further, and then advanced to a winder 38 where it is wound into rolls. The foam web 30 may be cured for two to three days or other time sufficient for the blowing agent to diffuse out of the structure and air to diffuse into the structure. It will be appreciated that the present invention is not limited to the technique described above for forming foam web 30, but that other available techniques are contemplated herein. For example, rather than an annular die, the polymer/blowing agent mixture may be extruded through a die having the cross-sectional shape of foam web 30, thereby eliminating the need for the slitting and flattening steps described above.

Generally, foam webs 30 for use in the present invention have a thickness between surfaces 32 and 34 (i.e., not including the height of ribs 22) of between about 0.01 inches and about 1.50 inches, depending upon the material from which the web is formed and the application in which the insulating laminate is to be used. Further, the width of foam web 30 is limited only by manufacturing capabilities and shipping, handling and installation considerations.

The foam webs 30 for use in the present invention have a generally low density, preferably between about 0.15 lb/ft³ and about 15 lb/ft³. Most preferred are foam webs having a density of less than about 3 lb/ft³. The low density of the webs results from the high volume of pores dispersed therein. This high volume of pores adds to the insulating properties of the laminates formed from the foam webs.

Once the foam structure has sufficiently cured, a metal layer is laminated to the corrugated side of the web. The metal layer may be in the form of a metal foil, such as an aluminum foil, or may be a film incorporating a layer of a metal. For example, the film may be a metallized polymer film. As used herein, the term “metallized polymer film” refers to polymer films having metal particles deposited thereon, such as by vapor deposition or other techniques. Such metallized polymer films typically have discontinuous metal layers. Although metallized polymer films may be used in the present invention, in preferred embodiments hereof the metal layer is a continuous layer of metal which acts both as a barrier to reflect and dissipate heat and as a barrier to moisture.

Preferred embodiments of the invention utilize a film 50 which includes a continuous layer of metal 52 and a polymer layer 54 adhered to one side thereof. While it is difficult to adhere a metal foil directly to an expanded polymer foam, the polymer layer 54 is easily laminated to the foam and forms a strong bond therewith. Preferred films of this type have a metal layer thickness of between about 0.05 mil and about 2 mil, a polymer layer thickness between about 0.50 mil and about 19 mil, and a total thickness of between about 0.5 mil and about 20 mils. The polymer layer 54 may be formed from substantially the same polymer as is used to form foam web 30, or from a different polymer which is easily adhered to foam web 30. A particularly preferred film for laminating to low density polyethylene foams consists of an aluminum foil laminated to a low density polyethylene film. Such film is available from Reflectix, Inc. of Markleville, Ind. and is available in different thicknesses. Films having a thickness of about 1.5 mil or about 2.8 mil are preferred, both of which have an aluminum foil thickness of about 0.315 mil, with the balance being the polyethylene film. As with foam web 30, film 50 (or the metal layer itself) can include one or more additives such as antioxidants, anti-corrosion agents, UV stabilizers, anti-bacterial agents, anti-microbial agents, anti-fungal agents, anti-static agents, biostabilizers and/or other functional additives depending on the commercial application of the laminate.

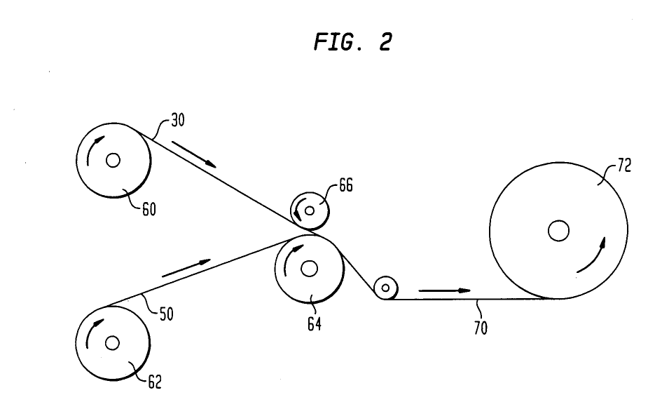

The lamination of film 50 to foam web 30 may be accomplished by any known technique, including the application of an adhesive, including molten polymer, between film 50 and foam web 30; ultrasonic welding techniques; thermal welding techniques; and the like. A particularly preferred technique is a conventional heat lamination process shown schematically in FIG. 2. In such process, foam web 30 and film 50 are fed from rollers 60 and 62, respectively, with ribs 22 of the foam web confronting polymer layer 54 of the film. The materials come together at a heated roller 64 which heats film 50 to a temperature sufficient to tackify the polymer layer 54. The heated film 50 and foam web 30 then pass through a nip formed between heated roller 64 and a nip roller 66 which presses the materials together, whereupon the polymer layer 54 of film 50 adheres to the foam web. More particularly, the polymer layer 54 of film 50 adheres to the free edges of ribs 22 in foam web 30, thereby creating a film/foam laminate 70 which is accumulated on a take-up roller 72.

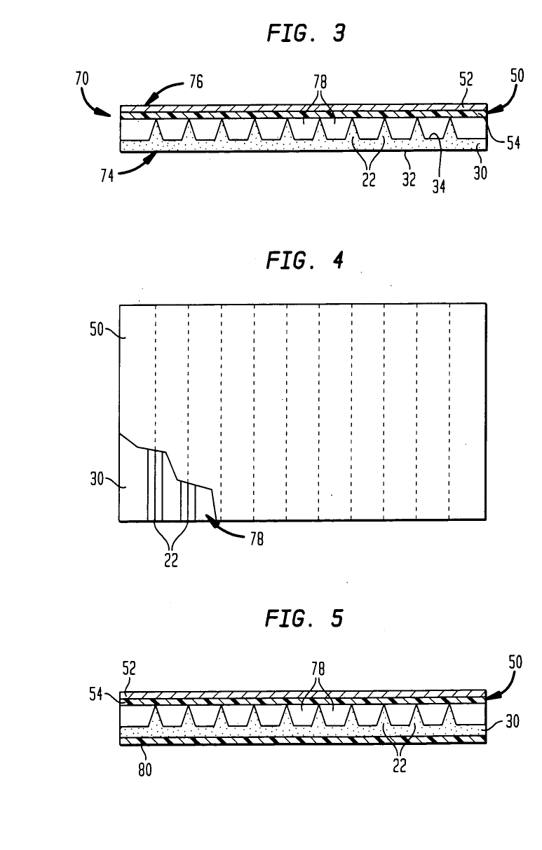

A film/foam laminate 70 in accordance with the present invention is illustrated in FIGS. 3 and 4. Laminate 70 has a bottom surface 74 defined by the flat surface 32 of foam web 30, and a top surface 76 defined by the metal layer 52 of film 50. Ribs 22 of foam web 30 extend in the length direction of laminate 70 so that a plurality of channels 78 are formed between surface 34, film 50 and each adjacent pair of ribs 22.

As will be appreciated, the height and spacing of ribs 22 will determine the width and height dimensions of channels 78. Generally speaking, laminates 70 in which channels 78 have larger volumes will have superior insulating properties than laminates 70 in which channels 78 have smaller volumes. Accordingly, the height and spacing of ribs 22 will depend upon the application for laminate 70 and the material forming foam web 30. While ribs 22 may be separated from one another by any amount, in preferred arrangements, ribs 22 are spaced so that channels 78 have a width 22 which is at least as great as the width of each rib 22 where it meets surface 34 of foam web 30. In addition, ribs 22 preferably have a height which is greater than the thickness of foam web 30 between surfaces 32 and 34. More preferred are ribs 22 which have a height which is at least about twice as large as the thickness of foam web 30 between surfaces 32 and 34.

Although ribs 22 are depicted in FIG. 3 as having a generally triangular shape, that need not be the case. That is, ribs 22 may be formed with any geometry which will create channels 78 upon the lamination of film 50 to the free edges of the ribs. Thus, ribs 22 may have shapes which are rectangular, semicircular, etc. Moreover, all of the ribs 22 in foam web 30 may be uniform in shape and size, or some of the ribs may have a different shape or size from others of the ribs. Where some ribs 22 are shorter than others, film 50 may or may not be laminated to the shorter ribs. Furthermore, ribs 22 need not be continuous along the entire length of foam web 30. Thus, there may be applications in which it is desirable for at least some of ribs 22 to have periodic or random breaks which define passageways connecting adjacent channels 78.

Optionally, film/foam laminate 70 may have a second film 80 laminated to surface 32 of foam web 30, as shown in FIG. 5. Film 80 may be any film which will provide a particularly desirable property to the laminate. For example, film/foam laminate 70 may include a high density polyethylene film laminated to surface 32. Laminates including this additional film layer may be desirable, for example, in situations in which a superior moisture barrier or increased toughness is needed. Film 80 may also be the same as film 50. In other words, foam web 30 may have film 50 laminated to both sides thereof. Film 80 may be laminated to surface 32 of foam web 30 by repeating the technique described above for laminating film 50 to foam web 30, or by any other known technique, including those noted above. Alternatively, by replacing nip roller 66 with a heated roller, films 50 and 80 may be laminated to foam web 30 simultaneously in a single process.

In a variant of the present invention, the foam web may be formed with two corrugated surfaces, that is, with ribs 22 protruding both from surface 34 and from surface 32. The ribs 22 protruding from surface 32 may have the same or different dimensions than the ribs 22 protruding from surface 34. Such foam structures may be formed directly by an appropriately shaped extrusion die, or by adhering two foam webs 30 to one another in back to back relationship. Each side of the foam web may then have the same or different films 50 laminated to the free edges of the ribs, forming a laminate having a central foam web and enclosed channels 78 extending longitudinally on both sides thereof. Such laminates will trap greater amounts of air therein, and thereby exhibit greater insulating properties.

Film/foam laminate 70 may be used in any number of applications in which a high quality insulating material is desired. One such use is as an insulating material in the construction of houses, offices and other buildings. In such structures, laminate 70 is ordinarily applied over plywood sheathing or another building substructure with foam web 30 facing toward the building and film 50 facing away from the building. An outer finish layer, such as wood, aluminum or vinyl siding or shingles is then installed over laminate 70. When used in this way, channels 78 in laminate 70 create air spaces which serve to insulate the interior of the building from extreme outside temperatures. However, because the ends of channels 78 are open, with proper installation of laminate 70, the air within the channels will not stagnate, but can over time flow out from one end of the channels while being replaced with fresh air at the other end of the channels. Therefore, moisture or other vapors will not accumulate between the substructure and the outer finish layer, but can easily escape therefrom.

Film/foam laminate 70 may also be used as an underlayment to provide heat insulation, sound insulation and a barrier to moisture emanating from a concrete floor to a wood or laminate floor. In view of these properties, the laminate of the present invention is suitable for use on basement floors, as well as under conventional laminate or wood floor installations. The film/foam laminate may serve as an underlayment between the floor substructure and the wood or laminate finish layer.

The film/foam laminate of the present invention also may be used as reflective insulation and/or as an air flow system for attics, crawl spaces, side walls, masonry walls, basement walls, plumbing and HVAC systems, metal buildings, modular houses, and other construction applications.

Furthermore, laminate 70 may be used to wrap certain components of refrigeration systems since it controls heat and prevents ultraviolet and infrared rays from attacking the equipment. Other typical uses include as a pipe wrap, hot water heater wrap, duct wrap and as a window covering. It may also be used as a safety wrap for appliances that produce heat.

Certain features of the present invention as described above are illustrated in the following example.

### EXAMPLE 1

A low density polyethylene resin having a melt index of 2 g/10 min and a density of 0.919 g/cm³ was combined in the feed zone of the primary extrusion chamber in a tandem extruder with 0.15 wt % of a nucleating agent masterbatch containing 50 wt % active talc and 50 wt % of the same low density polyethylene resin, and 1.2 wt % of a permeation modifier mixture containing 66.7 wt % glycerol monosterate in 33.3 wt % monoethanolamide. The components were intricately mixed to form a homogonous polymer mixture. The mixture was then conveyed to the melt zone of the extruder and heated to a temperature of about 350° F. to form a molten mass. About 11-12 wt % (based on the weight of the resin) of a propane blowing agent was injected into the molten mass using a metering and pumping unit, and mixing continued until a homogenous blowing agent/polymer mixture was formed. This mixture was then conveyed to the secondary extrusion chamber in which it was cooled to a temperature of about 230.5° F. Once stabilized, the mixture was extruded through an annular die at a temperature of 230.5° F. to form a foam tube which, after expansion, has an outer diameter of about 19.09 inches and an inner diameter of about 18.654 inches. The foam tube was then conveyed under ambient conditions to a cutting station and slit longitudinally to form a corrugated foam sheet having a thickness of about 0.218 inches (including the height of the projecting ribs), a width of about 60 inches and a bulk density of about 0.75 lbs/ft³.

After a curing period of about 5 days, the corrugated foam web was heat laminated at a temperature of about 280° F. to either a 1.5 mil or a 2.8 mil metal foil/polymer film. The 1.5 mil film was composed of a 0.315 mil layer of aluminum foil adhered to a 1.185 mil layer of low density polyethylene, while the 2.8 mil film was composed of a 0.315 mil layer of aluminum foil adhered to a 2.485 mil layer of low density polyethylene.

Each laminate sample was tested to determine the thermal resistance values of the laminate using the ASTM C518 test method. As a comparison, a non-corrugated low density polyethylene expanded foam web formed under standard forming conditions was laminated to the same films. Table 1 below shows the test results for these various laminates.

TABLE 1

| | Thickness, | R-Value |
|---|---|---|
| | Inches | Ft²Hr ° F./BTU |
| Non-corrugated | 0.196 | 0.80 |
| foam/1.5 mil film | | |
| Corrugated foam/1.5 mil | 0.207 | 0.83 |
| film | | |
| Non-corrugated | 0.196 | 0.76 |
| foam/2.8 mil film | | |
| Corrugated foam/2.8 mil | 0.196 | 0.78 |
| film | | |

As shown in the table, higher thermal resistance values were obtained with the corrugated foams than with the non-corrugated foams, regardless of the thickness of the film adhered to the foam web.

### EXAMPLE 2

The corrugated foam web of Example 1 was laminated to two different films each having a thickness of 2.8 mil. The first film consisted of an aluminum foil layer having a thickness of 0.315 mil adhered to a low density polyethylene layer having a thickness of 2.485 mil. The second film was a metallized film consisting of a 2.8 mil thick low density polyethylene film to which aluminum particles were deposited using standard deposition techniques so as to form a noncontinuous metal layer on the film. Each sample was tested to determine its near-normal infrared reflectance in accordance with test method ASTM E408-71, Method A, using a Gier Dunkle Instruments Infrared Reflectometer Model DB100. The emittance of each laminate was then calculated based on the formula emittance=1−reflectance. Table 2 below shows the test results for the two samples.

TABLE 2

| | Reflectance | Emittance |
|---|---|---|
| Corrugated foam/2.8 mil | 0.50 | 0.50 |
| metallized film | | |
| Corrugated foam/2.8 mil | 0.96 | 0.04 |
| foil-film | | |

As shown in Table 2, laminates in which the film layer incorporates a continuous metal layer, such as an aluminum foil layer, exhibit superior reflectivity than laminates employing metallized films. As a result of this greater reflectivity, the laminates including a continuous metal layer in the film layer provide better insulation performance than laminates having a metallized film in the film layer.

All numerical ranges recited herein include all subranges therebetween as if expressly set forth.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An insulating material, comprising
a foam web including a polymer matrix and a multiplicity of voids dispersed throughout said polymer matrix, said foam web extending in a length direction and having first and second surfaces, said foam web having a plurality of spaced ribs projecting from said first surface and oriented in said length direction; and
a film including a metal layer adhered to free edges of said spaced ribs so as to define a plurality of enclosed channels extending in said length direction, each of said enclosed channels being delimited by said first surface, said film and an adjacent pair of said ribs.

2. The insulating material as claimed in claim 1, wherein said metal layer includes a continuous layer of metal.

3. The insulating material as claimed in claim 1, wherein said film includes a polymer layer disposed between said metal layer and said foam web.

4. The insulating material as claimed in claim 3, wherein said polymer layer is formed from a polyolefin.

5. The insulating material as claimed in claim 3, wherein said polymer layer in said film is formed from substantially the same polymer as said polymer matrix in said foam web.

6. The insulating material as claimed in claim 5, wherein said polymer layer is formed from polyethylene and said polymer matrix in said foam web is formed from polyethylene.

7. The insulating material as claimed in claim 1, wherein said metal layer is formed from aluminum.

8. The insulating material as claimed in claim 7, wherein said metal layer is formed from an aluminum foil.

9. The insulating material as claimed in claim 1, wherein said film has a thickness between about 0.5 mil and about 20 mils.

10. The insulating material as claimed in claim 1, wherein said foam web has a density between about 0.5 lb/ft³ and about 15 lb/ft³.

11. The insulating material as claimed in claim 10, wherein said foam web has a density of less than about 3 lb/ft³.

12. The insulating material as claimed in claim 1, wherein said foam web is formed from low density polyethylene.

13. The insulating material as claimed in claim 12, wherein said film includes a layer of low density polyethylene.

14. The insulating material as claimed in claim 1, wherein said foam web has a predetermined thickness between said first and second surfaces, and said ribs project from said first surface by a height dimension, said height dimension being greater than said predetermined thickness.

15. The insulating material as claimed in claim 14, wherein said height dimension is at least about twice as large as said predetermined thickness.

16. The insulating material as claimed in claim 14, wherein said foam web has an overall thickness including said predetermined thickness and said height dimension of between about 0.02 inches and about 4 inches.

17. The insulating material as claimed in claim 1, wherein each of said ribs has a width at a junction with said first surface, and each of said ribs is separated by an adjacent one of said ribs by at least said width.

18. The insulating material as claimed in claim 1, further comprising another film adhered to said second surface of said foam web.

19. The insulating material as claimed in claim 18, wherein said another film is formed from high density polyethylene.

20. The insulating material as claimed in claim 18, wherein said another film includes a metal layer.

21. The insulating material as claimed in claim 20, wherein said another film is formed from the same material as said film.

22. The insulating material as claimed in claim 1, wherein said foam includes at least one additive selected from the group consisting of antioxidants, colorants, anti-corrosion agents, anti-bacterial agents, anti-microbial agents, anti-fungal agents, anti-static agents, UV stabilizers, fillers, reinforcements, biostabilizers and pigments.

23. The insulating material as claimed in claim 1, wherein said metal layer includes at least one additive selected from the group consisting of antioxidants, anti-corrosion agents, anti-bacterial agents, anti-microbial agents, anti-fungal agents, anti-static agents, UV stabilizers and biostabilizers.

24. An insulating material, comprising
a foam web including a polymer matrix and a multiplicity of voids dispersed throughout said polymer matrix, said foam web extending in a length direction and having first and second surfaces, said foam web having a plurality of spaced ribs projecting from said first surface and oriented in said length direction; and
a metal layer adhered to free edges of said spaced ribs so as to define a plurality of enclosed channels extending in said length direction, each of said enclosed channels being delimited by said first surface, said metal layer and an adjacent pair of said ribs.
